(19) United States
(12) Patent Application Publication
(10) Pub. No.: US 2026/0121888 A1
(43) Pub. Date: Apr. 30, 2026

(54) Avionic ring communication network, and related civil aircraft

(71) Applicant: THALES, Meudon (FR)

(72) Inventor: Pierre JOUANNA, TOULOUSE (FR)

(21) Appl. No.: 19/370,953

(22) Filed: Oct. 28, 2025

(30) Foreign Application Priority Data
Oct. 31, 2024 (FR) FR2411939

(51) Int. Cl. H04L 12/423; H04L 12/437; H04L 67/12

(52) U.S. Cl. CPC H04L 12/423; H04L 12/437; H04L 67/12

(57) ABSTRACT

An avionics ring communication network includes at least three communication nodes connected to each other. Each node includes a pair of communication ports and is connected between the respective previous and following nodes. At least one node includes a sequencing module configured to generate data transport frames. Each node is intended to be connected to respective avionics equipment and includes a processing module to receive data, via the frames, intended for the equipment and/or to send data from the equipment. At a given time, only one of the nodes is configured to generate the transport frames, the sequencing module being activated for only one of the nodes at a time.

### CROSS-REFERENCE TO RELATED APPLICATIONS

This application is a U.S. non-provisional application claiming the benefit of French Application No. 2411939, filed on October 31, 2024, which is incorporated herein by reference in its entirety.

### FIELD

The present invention relates to an avionics communication network, intended to be onboard an aircraft.

The invention also relates to a civil aircraft comprising such an avionics communication network and avionics equipment interconnected via said network.

The invention is in the field of internal communication networks in avionics, or more generally in embedded networks that are highly constrained in terms of availability (redundancy) and integrity (content verification with temporally deterministic exchanges).

### BACKGROUND

The ARINC 664 Part 7 standard, also noted as A664 p7, has become established in recent major aircraft programs as an internal communication network in embedded avionics. It is a star network organized around several switches allowing much onboard equipment to be connected. This standard provides a high level of data transport integrity and also allows a high level of network availability by duplicating the communication routers in order to be tolerant to router failures.

However, a network compliant with this standard has the following drawbacks.

The size, weight and power consumption, or SWaP (Size, Weight and Power), of such a network are not optimal. Indeed, such a network imposes at least two switches to ensure network integrity, and often a larger number of these switches to ensure network availability, which degrades the size, weight, and power consumption of the solution. It should be noted that this type of network presents a significant SWaP penalty for small networks: as soon as one wants to connect three pieces of equipment, two switches are needed to ensure the integrity and availability of this mini-network.

The cost of the switches degrades the overall cost of such a network, and the reliability of the switch is taken into account by the redundancy of communication links and therefore of the switches.

The switches generate a switching delay, causing latency in data transmission. This latency depends on the topology of the switches, but also on the volume of data switched. A worst-case latency can be calculated, once all data flows are known, through a statistical analysis tool. The latency variation, or jitter, affecting each packet of data is also calculated and must be controlled and contained, which imposes a low utilization rate of the theoretical bandwidth, below 50%.

Such a network also lacks determinism, and the designers of architectures based on such a network deal with a worst-case latency and jitter, which restricts the field of use to "soft" real-time architectures. For example, voice transport over the network, which is very sensitive to jitter, can hardly be considered on such a network, nor can systems with millisecond data calculation needs. Moreover, if new equipment is added to such a network, with new data flows, the classification of the network in terms of latency and jitter must be completely redone.

### SUMMARY

The aim of the invention is to propose an improved avionics communication network.

To this end, the invention relates to an avionics ring communication network, intended to be onboard an aircraft and comprising at least three communication nodes interconnected in a ring shape, each communication node including at least one pair of communication ports and being directly connected between a respective previous node and a following node via two respective distinct ports, the communication ports of two successive nodes of the ring being connected via a wired data link, at least one communication node including a sequencing module configured to generate data transport frames, each frame circulating in a loop successively from node to node, each communication node being intended to be connected to a respective avionics equipment and including a processing module configured to receive data, via the generated frames, intended for said avionics equipment from other avionics equipment and/or to send data from said avionics equipment to at least one other avionics equipment, at a given time, only one of the communication nodes being configured to generate the data transport frames, the sequencing module being activated for only one of the communication nodes at a time.

According to other advantageous aspects of the invention, the network comprises one or more of the following features, taken individually or in any technically possible combination: - each communication node includes the sequencing module and the processing module; - at least one communication node includes a monitoring module configured to compare an inter-frame period to a predefined range of values, a frame anomaly being detected if the inter-frame period is not within said range, the inter-frame period being the difference between two temporal instances of receiving successive frames by the node including the monitoring module; each communication node preferably including the monitoring module and the processing module; the monitoring module preferably being activated for all communication nodes; - each communication node includes the sequencing module, the monitoring module, and the processing module; the monitoring module preferably being activated for all communication nodes; - among the communication nodes, two communication nodes, called master nodes, each include the sequencing module and the monitoring module, the sequencing module then being activated for one master node, called the active master node, and the monitoring module being activated for the other master node, called the passive master node; the communication nodes, called slave nodes, other than the master nodes preferably including only the processing module among the sequencing, monitoring, and processing modules; - each communication node includes a first pair of communication ports and a second pair of communication ports, redundant to the first pair; the communication ports of the first pairs being successively connected via first wired data links, and the communication ports of the second pairs being successively connected via second wired data links, redundant to the first links; - between two successive nodes of the ring, the first and second wired links are arranged in parallel to each other; and the processing modules of said nodes are configured to circulate data in a first direction on the first link, and in a respective second direction, opposite to the first direction, on the second link; - each pair of ports includes a receiver port and a transmitter port; and + if both ports of the first pair are functional, the processing module is configured to acquire a frame received on the receiver port of the first pair, to process said frame, then to send the processed frame via the transmitter port of the first pair; and the processing module is configured to transfer, without processing, to the transmitter port of the second pair, each frame received on the receiver port of the second pair; + if the receiver port of the first pair is non-functional, the processing module is configured to acquire a frame received on the receiver port of the second pair, to process said frame, then to send the processed frame via the transmitter port of the first pair; and + if the transmitter port of the first pair is non-functional, the processing module is configured to acquire a frame received on the receiver port of the first pair, to process said frame, then to send the processed frame via the transmitter port of the second pair; - the sequencing module is configured to generate the data transport frames in the form of virtual links according to the ARINC 664 Part 7 standard, and to associate a respective inter-frame space to each virtual link, the inter-frame space being a minimum duration between temporal instances of the start of two successive frames of the corresponding virtual link; and - for each data transport frame, the processing module of only one respective node is authorized to write data in said frame for sending data to one or more of the other equipment, and the processing modules of all other nodes are authorized only to read data from said frame.

- at least one communication node includes an additional pair of communication ports configured to be connected to another communication network;

The invention also relates to an aircraft comprising an avionics ring communication network as defined above, and avionics equipment interconnected via said network.

### BRIEF DESCRIPTION OF THE DRAWINGS

The invention will become clearer upon reading the following description, given solely by way of non-limiting example, and made with reference to the drawings wherein:

FIG. 1 is a schematic representation of an aircraft according to the invention, comprising an avionics installation including an avionics communication network and avionics equipment interconnected via said network, the network including a plurality of communication nodes connected in a ring shape;

FIG. 2 is a more detailed schematic representation of a master communication node and respective slave communication node; as well as the generation of data transport frames, by the master node, in the form of virtual links;

FIG. 3 is a representative view of the temporal spacing between data transport frames; as well as the structure of a respective frame;

FIG. 4 is a view illustrating the reconfiguration of the avionics ring communication network of FIG. 1 in case of a respective communication node malfunction;

FIG. 5 is a schematic representation of two avionics ring communication networks, connected to each other; and

FIG. 6 is a schematic representation of a first avionics installation with two avionics ring communication networks connected to each other and interconnecting avionics equipment such as display screens, electronic computing boards, and electronic input-output boards; and of a second respective avionics installation similar to the first installation where the avionics equipment is also interconnected via a third star communication network.

### DETAILED DESCRIPTION

In the following description, the expression "substantially equal to" defines an equality relationship of plus or minus 20%, preferably plus or minus 10%, more preferably plus or minus 5%.

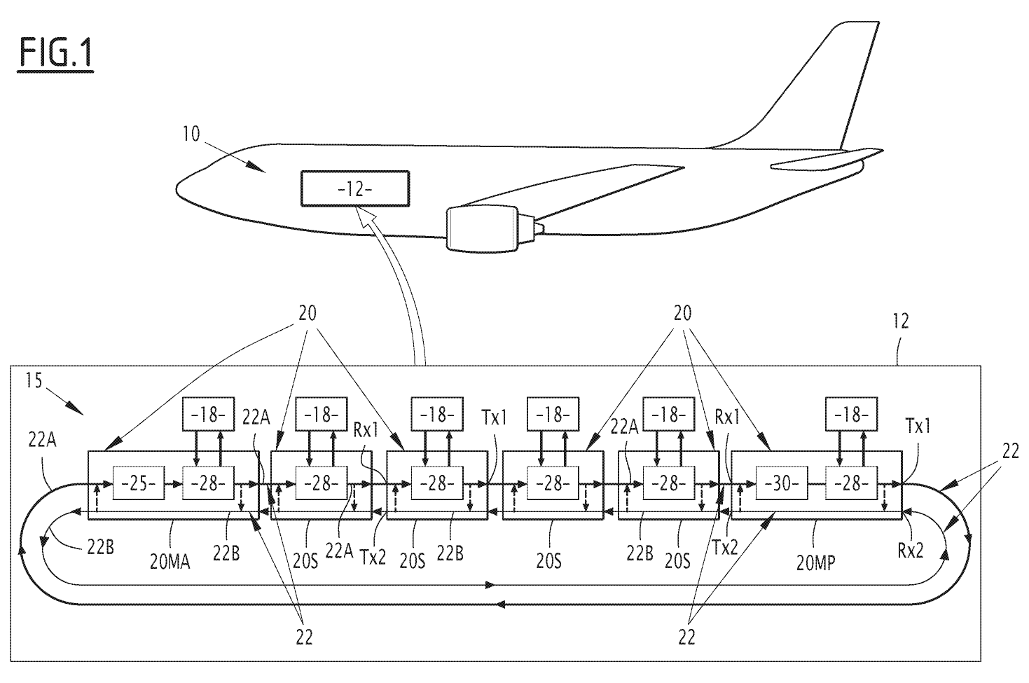

In FIG. 1, a civil aircraft 10 comprises an avionics installation 12 including an avionics ring communication network 15 and avionics equipment 18 interconnected via said network 15.

The civil aircraft 10 is notably a commercial airplane, as shown in FIG. 1. In a variant, the civil aircraft 10 is a rotary-wing aircraft, such as a civil helicopter, or even a civil drone remotely piloted by a teleoperator.

The avionics communication network 15 is intended to be onboard the aircraft 10, and comprises at least three communication nodes 20 connected in a ring shape, via respective wired data links 22.

The avionics communication network 15 is advantageously constituted of said communication nodes 20 and the wired links 22 interconnecting said nodes 20.

Among the nodes 20 of the communication network 15, some nodes 20 are called master nodes and then noted 20M, and more specifically 20MA for an active master node, 20MP for a passive master node; and other nodes 20 are called passive nodes and then noted 20S, as will be described in more detail later. The reference 20 used for communication nodes will then generally designate both the master nodes 20MA, 20MP and the slave nodes 20S.

The avionics communication network 15 includes at least one active master node 20MA and at least two other nodes 20S, 20MP.

Each communication node 20 takes the form of an electronic device and is intended to be connected to respective avionics equipment 18.

Each communication node 20 includes at least one pair of communication ports Rx1, Tx1, Rx2, Tx2, and is directly connected between a respective previous node 20 and a following node 20 via two distinct ports, noted Rx1, Tx1, or Rx2, Tx2 respectively, the communication ports Rx1, Tx1, Rx2, Tx2 of two successive nodes 20 of the ring being connected via a wired data link 22. Each pair of communication ports Rx1, Tx1, Rx2, Tx2 includes a receiver port Rx1, Rx2 configured to receive data from the transmitter port Tx1, Tx2 of a previous node 20, and a transmitter port Tx1, Tx2 configured to send data to the receiver port Rx1, Rx2 of a following node 20.

Optionally, each communication node 20 includes a first pair of communication ports Rx1, Tx1 and a second pair of communication ports Rx2, Tx2, redundant to the first pair Rx1, Tx1. The communication ports Rx1, Tx1 of the first pairs are successively connected via first wired data links 22A. The communication ports of the second pairs Rx2, Tx2 are successively connected via second wired data links 22B, redundant to the first links 22A. The first pair of communication ports Rx1, Tx1 is also called the primary pair, and, similarly, each first wired link 22A is also called the primary wired link. The second pair of communication ports Rx2, Tx2 is also called the secondary pair, and, similarly, each second wired link 22B is also called the secondary wired link, the second pair of communication ports Rx2, Tx2 and the associated second wired links 22B being redundant elements of the respective first pair of communication ports Rx1, Tx1 and the associated first wired links 22A, and used secondarily when a port of the first pair Rx1, Tx1 and/or a first wired link 22A used primarily is non-functional, i.e., non-operational, for example out of service, or broken.

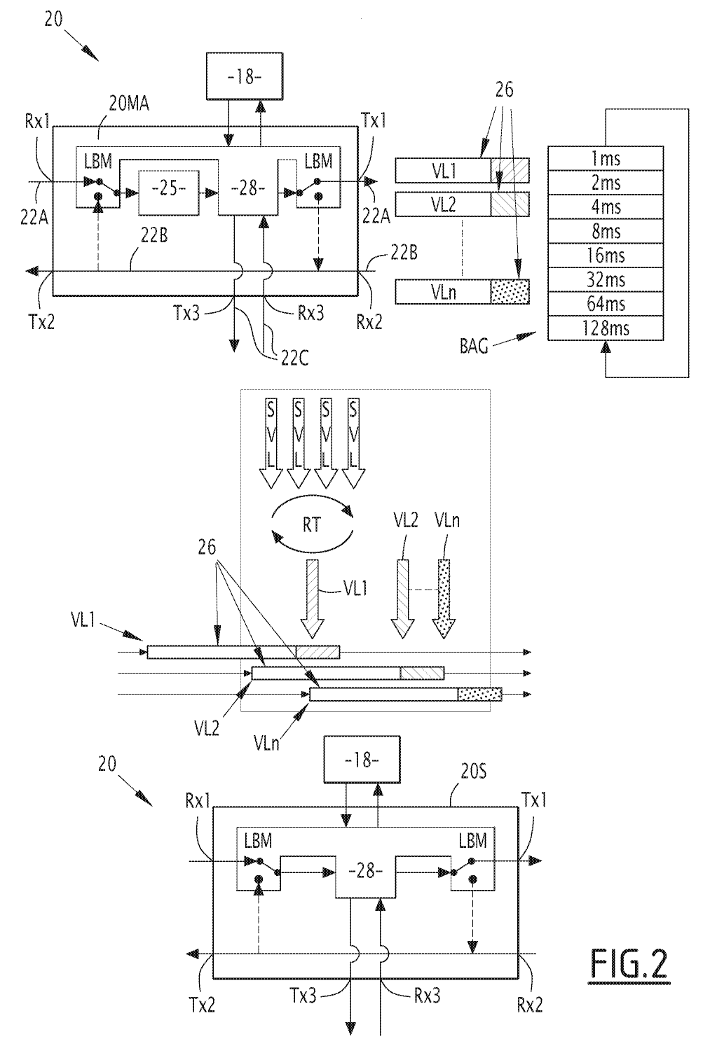

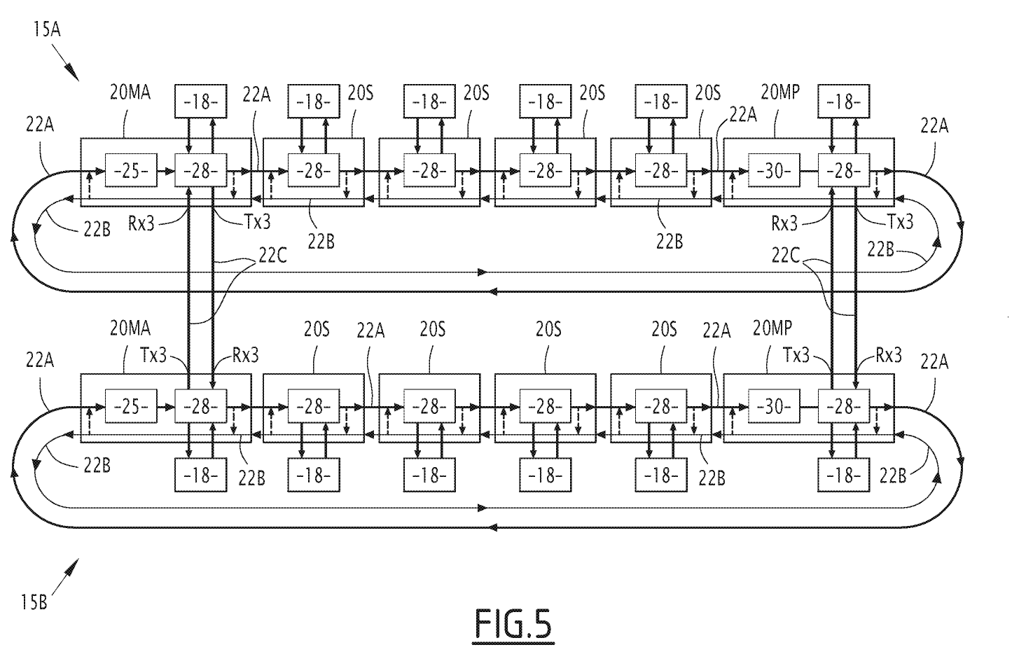

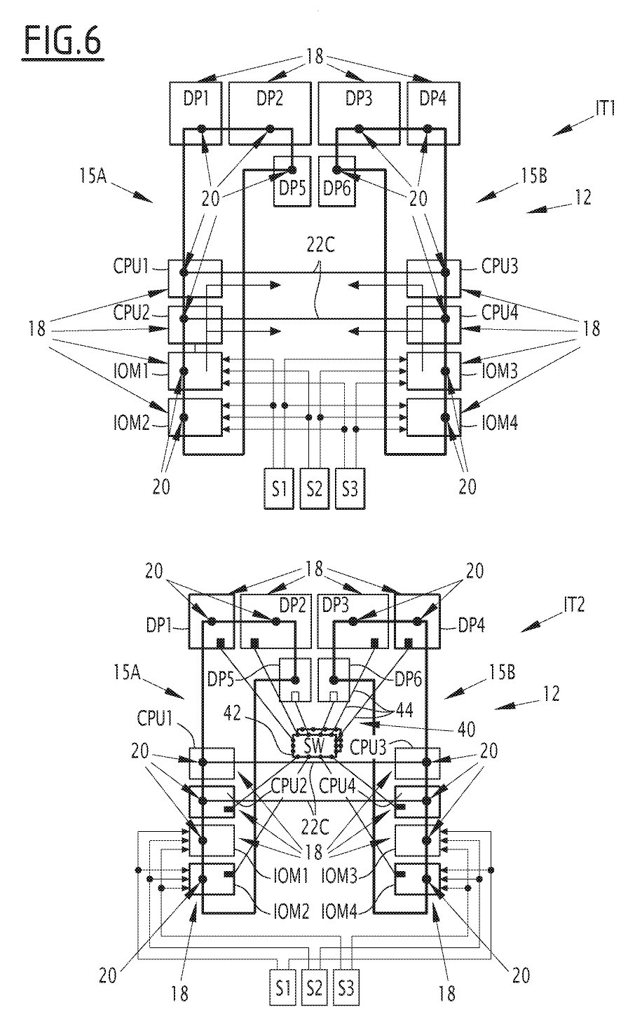

Also optionally, at least one communication node 20 includes an additional pair of communication ports Rx3, Tx3, visible in FIG. 2, configured to be connected to another communication network 15A, 15B, as shown in the examples of FIGS. 5 and 6, described in more detail later.

At least one communication node 20MA includes a sequencing module 25 configured to generate data transport frames 26, each frame 26 circulating in a loop successively from node 20 to node 20. Advantageously, each frame 26 traverses a respective node 20 with a traversal time substantially equal to 1 microsecond (µs).

The at least one communication node including the sequencing module 25 is typically a master node, noted 20MA or 20MP, and preferably an active master node 20MA, the generation of transport frames 26 allowing sequencing of these frames 26, with management of the temporal spacing between frames 26, as will be described hereafter.

Advantageously, each communication node 20 includes the sequencing module 25, and the sequencing module 25 is then preferably activated for only one of the communication nodes 20, such as the active master node 20MA.

Each communication node 20 comprises a processing module 28 configured to receive data, via the generated frames 26, intended for said avionics equipment 18 from other avionics equipment 18 and/or to send data from said avionics equipment 18 to at least one other avionics equipment 18. In other words, the processing module 28 is configured to read on-the-fly data intended for said avionics equipment 18, via the frames 26 that traverse the corresponding node 20, and/or to write on-the-fly data from said avionics equipment 18 to at least one other avionics equipment 18.

Advantageously, each communication node 20 includes the sequencing module 25 and the processing module 28, and the sequencing module 25 is then activated for only one of the communication nodes 20, such as the active master node 20MA.

At least one communication node 20MP includes a monitoring module 30 configured to compare an inter-frame period to a predefined range of values, a frame anomaly being detected if the inter-frame period does not belong to said range. The inter-frame period is the difference between two temporal instances of reception of successive frames 26 by the node 20MP including the monitoring module 30. In other words, the monitoring module 30 is configured to verify the correct periodicity of the frames 26.

The at least one communication node including the monitoring module 30 is typically a master node, noted 20MA or 20MP, and preferably a passive master node 20MP, the monitoring being performed passively, without interaction on the frame sequence 26.

Advantageously, each communication node 20 includes the monitoring module 30 and the processing module 28. The monitoring module 30 is then preferably activated for all communication nodes 20.

Advantageously again, each communication node 20 includes the sequencing module 25, the monitoring module 30, and the processing module 28, the sequencing module 25 is activated for only one 20MA of the communication nodes 20, such as the active master node 20MA. The monitoring module 30 is then preferably activated for all communication nodes 20.

According to this advantageous aspect, not shown, all communication nodes 20 are preferably materially identical, each node 20 also being called a connection node, allowing avionics equipment 18 to be connected to the network. The skilled person will then observe that, although materially identical, these nodes 20 do not all have the same role during the operation of the avionics communication network 15, and in particular that the sequencing module 25 is activated for only one node 20 among all the nodes 20 of the network 15, this node being typically called a master node, the other nodes being called slave nodes.

This advantageous aspect allows further reduction of the mass of the communication network 15 since it is then unnecessary to have one or more dedicated master nodes. This advantageous aspect also improves the reliability of the communication network 15, in particular providing more redundancy for the master node, since, in case of failure of the node fulfilling the role of master node, any other node can take over and, in turn, play the role of master node. Typically, in case of failure of the node 20 playing the role of master node, this node 20 will be isolated from the communication network 15, and another node 20, such as the node following the failing node, will then be configured to newly fulfill the role of master node, by then activating the sequencing module 25 for said node 20 newly forming the master node.

In a variant of this advantageous aspect, among the communication nodes 20, two communication nodes 20, called master nodes 20MA, 20MP, each include the sequencing module 25 and the monitoring module 30, as well as the processing module 28. According to this variant, the sequencing module 25 is then activated for one master node, called the active master node 20MA, and the monitoring module 30 is activated for the other master node, called the passive master node 20MP.

According to this variant, the nodes 20 other than the master nodes 20MA, 20MP, these other nodes also being called slave nodes 20S, preferably include only the processing module 28 among the sequencing, monitoring, and processing modules.

Each node 20 typically includes an information processing unit formed, for example, of a memory and a processor associated with the memory, not shown.

According to this example, the sequencing module 25, the processing module 28, and the monitoring module 30, when present in said corresponding node 20, are each made in the form of software, or a software brick, executable by the processor. The memory of the node 20 is then able to store sequencing software, processing software, and monitoring software if applicable. The processor is then able to execute each of the sequencing software, processing software, and monitoring software.

In a variant not shown, the sequencing module 25, the processing module 28, and the monitoring module 30, when present in said corresponding node 20, are each made in the form of a programmable logic component, such as an FPGA (Field Programmable Gate Array), or even in the form of a dedicated integrated circuit, such as an ASIC (Application Specific Integrated Circuit).

When the communication node 20 is made in the form of one or more software programs, i.e., in the form of a computer program, it is also able to be recorded on a medium readable by a computer, not shown. The computer-readable medium is a medium able to store electronic instructions and to be coupled to a bus of a computer system, for example. For example, the readable medium is an optical disk, a magneto-optical disk, a ROM memory, a RAM memory, any type of non-volatile memory (for example EPROM, EEPROM, FLASH, NVRAM), a magnetic card, or an optical card. On the readable medium a computer program comprising software instructions is then stored.

The sequencing module 25 is configured to generate the data transport frames 26, for example, in the form of virtual links VL1, VL2, ..., VLn according to the ARINC 664 Part 7 standard, as shown in FIG. 2.

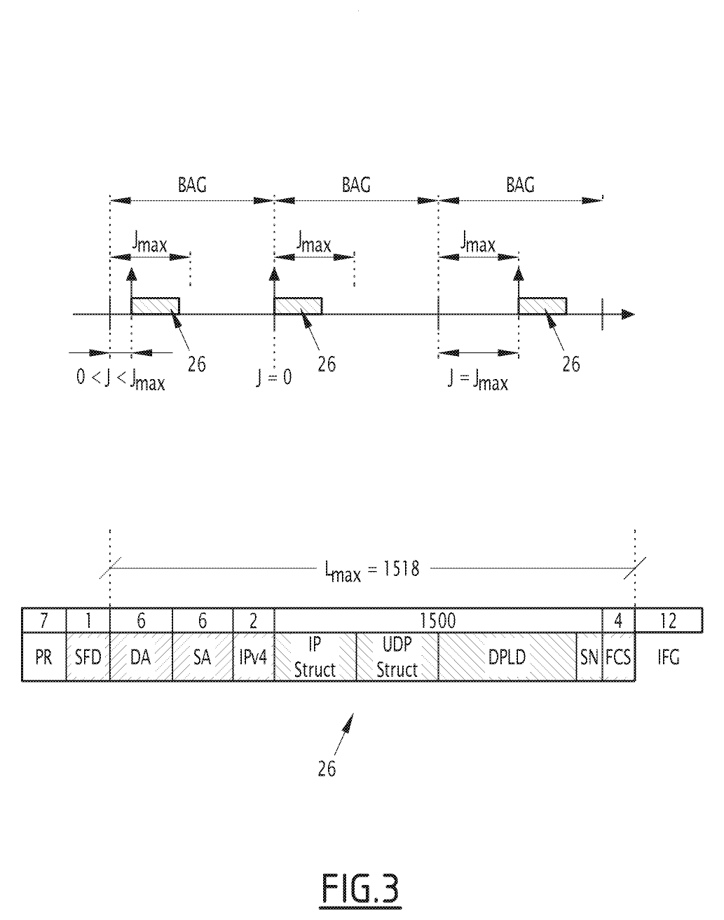

According to this optional complement, the sequencing module 25 is then configured to associate a respective inter-frame space BAG to each virtual link VL1, VL2, ..., VLn. The inter-frame space BAG is a minimum duration between temporal instances of the start of two successive frames 26 of the corresponding virtual link VL1, VL2, ..., VLn, as shown in FIG. 3. In the example of FIG. 3, a jitter J is represented for each frame 26, the value of the jitter J varying being between a null value and a maximum value noted Jmax.

In the example of FIG. 2, the inter-frame space BAG for each virtual link VL1, VL2, ..., VLn is chosen from a predefined set of values, such as the set including for example the values 250 µs (for microsecond), 500 µs, 1 ms (for millisecond), 2 ms, 4 ms, 8 ms, 16 ms, 32 ms, 64 ms, and 128 ms. Of course, other inter-frame space BAG values are possible, notably lower or higher than the aforementioned values.

The structure of each frame 26 is compliant with the ARINC 664 Part 7 standard, for example, and then successively includes the following fields, whose description and use are described in the ARINC 664 Part 7 standard, represented in FIG. 3, which corresponds to an excerpt from the ARINC 664 Part 7 standard, the numbers indicated above the field codes corresponding to the respective size in byte(s) of each field:

PR field, corresponding to a preamble,

SFD field (Start Frame Delimiter), forming a start frame indicator,

DA field (Destination Address), containing a destination address, i.e., an identifier of the avionics equipment 18 to which the data included in said frame 26 are intended,

SA field (Source Address), containing a source address, i.e., an identifier of the avionics equipment 18 that emitted the data included in said frame 26,

IPv4 field to specify the type of IP protocol,

IP Struct field (IP Structure),

UDP Struct field (UDP Structure),

DPLD field (Data Payload), containing the corresponding useful part of the frame 26, i.e., the useful data intended for the avionics equipment 18 identified in the DA field,

SN field (Serial Number),

FCS field (Frame Check Seq), and

IFG field (Inter Frame Gap), corresponding to the last field of the frame 26, and being a field left empty, to form a separation with the next frame 26 circulating on the communication network 15.

The length of the DPLD field forming the useful part of the frame 26 is typically variable. Each frame 26 then has a variable length, while having a maximum length Lₘₐₓ corresponding to all the fields DA to FCS, i.e., to all the aforementioned fields except the PR, SFD, and IFG fields. The maximum length Lₘₐₓ is equal to 1518 bytes, for example, and the frame 26 then has a length of at most 1526 bytes taking into account the PR and SFD fields, and at most 1538 bytes with the IFG field in addition.

The skilled person will also observe that in this example of the structure of FIG. 3, the SFD, DA, SA, and IPv4 fields, as well as FCS, are managed by the sequencing module 25 during the generation of each respective frame 26. The IP Struct, UDP Struct, and DPLD fields are managed by the node 20 having the right to emit, i.e., the right to write, on the corresponding frame 26, and in particular by the processing module 28 of said node 20 having the right to emit.

Optionally, the sequencing module 25 is configured to measure a looping delay of each respective frame 26 and compare the looping delay to a predefined range of values, a frame anomaly being detected if the looping delay does not belong to said range, the looping delay being the difference between two successive temporal instances of reception of said frame 26 by the node including the sequencing module 25. Indeed, the sequencing module 25 receives the frame it emits almost simultaneously, and can therefore detect an abnormal circulation delay in the loop formed by the nodes 20.

The processing module 28 of each node 20 is configured to receive data intended for the avionics equipment 18 associated with said node 20 via the corresponding frames 26 configured in reading and/or to transmit data intended for other equipment 18 via the corresponding frames 26 configured in writing.

Between two successive nodes 20 of the ring, the first 22A and second 22B wired links are arranged in parallel to each other; and the processing modules 28 of said nodes 20 are configured to circulate data in a first direction on the first link 22A, and in a second respective direction, opposite to the first direction, on the second link 22B.

For example, if both ports Rx1, Tx1 of the first pair are functional, i.e., operational, the processing module 28 is configured to acquire a frame 26 received on the receiver port Rx1 of the first pair, to process said frame 26, then to send the processed frame 26 via the transmitter port Tx1 of the first pair. In this case, i.e., if both ports Rx1, Tx1 of the first pair are functional, the processing module 28 is configured to transfer each frame 26 received on the receiver port Rx2 of the second pair to the transmitter port Tx2 of the second pair, without processing.

According to this example, the traversal time of the corresponding node 20 for the primary ring corresponding to the primary links 22A, i.e., the time taken by a respective frame 26 between its reception on the receiver port Rx1 and its emission via the transmitter port Tx1 is typically of the order of 1 µs (microsecond). The traversal time of the corresponding node 20 for the secondary ring corresponding to the secondary links 22B, i.e., the time taken by a respective frame 26 to be transferred without processing from the receiver port Rx2 or transmitter port Tx2 is typically much less than 1 µs, for example of the order of 0.1 µs.

Optionally, if the receiver port Rx1 of the first pair is non-functional, i.e., non-operational, the processing module 28 is configured to acquire a frame 26 received on the receiver port Rx2 of the second pair, to process said frame 26, then to send the processed frame 26 via the transmitter port Tx1 of the first pair.

Optionally again, if the transmitter port Tx1 of the first pair is non-functional, i.e., non-operational, the processing module 28 is configured to acquire a frame 26 received on the receiver port Rx1 of the first pair, to process said frame 26, then to send the processed frame 26 via the transmitter port Tx2 of the second pair.

The skilled person will understand that processing the frame 26 means reading data in the frame 26 and/or writing data in the frame 26.

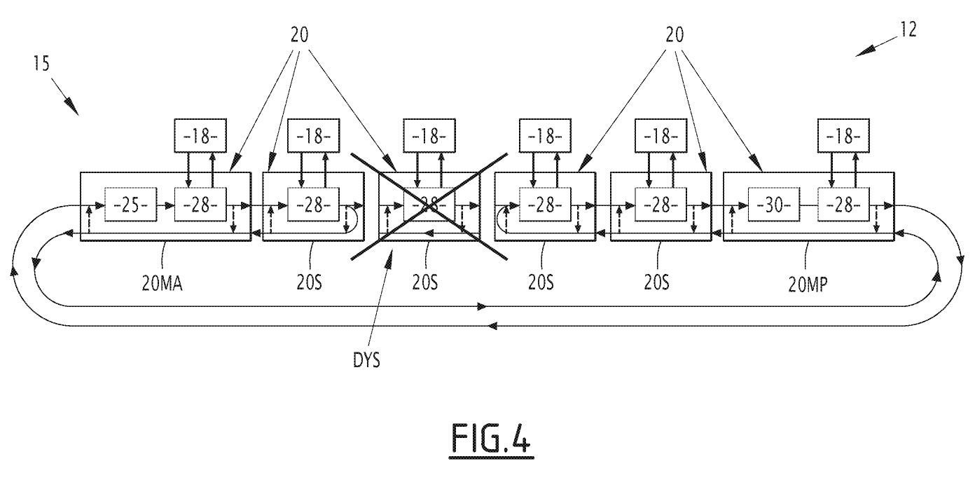

This mechanism implemented by the processing module 28 is also called a loopback mechanism, noted LBM (Loop Back Mechanism) in FIG. 2, and then allows maintaining a connection loop between operational nodes 20 to form the ring communication network 15 with the nodes 20 remaining operational, even in case of a malfunction of a failing node 20. This is represented in FIG. 4, where the failing node 20 is crossed out by a cross, and the other nodes 20 remaining operational are then connected to each other via the loop corresponding to the bold arrows.

In the example of FIG. 4, when a node 20 is completely broken, the loop is maintained between the nodes 20 remaining operational by implementing this loopback mechanism for the two nodes 20 located on either side of the failing node 20. More precisely, the node 20 located upstream of the failing node 20 in the direction of circulation of the frames 26 on the primary links 22A unable to send the frames to the failing node 20 via the transmitter port Tx1 of its first pair will then send these frames 26 via the transmitter port Tx2 of the second pair, i.e., on the secondary link 22B connected to this transmitter port Tx2, and then in the opposite direction to the direction of circulation of the frames 26 on the primary links 22A. For the node 20 located downstream of the failing node 20 in the direction of circulation of the frames 26 on the primary links 22A, the frames 26 will then circulate on the secondary links 22B, due to the loopback mechanism implemented on the upstream node, as described above, and this downstream node, unable to send the frames 26 to the failing node 20 via the transmitter port Tx2 of its second pair, will then send them via the transmitter port Tx1 of its first pair, i.e., on the primary link 22A connected to this transmitter port Tx1, and then in the direction of circulation of the frames 26 on the primary links 22A, also called the direct direction, and therefore again towards the upstream node.

With this loopback mechanism LBM, the ring communication network 15 according to the invention remains operational even in case of failure of one of its communication nodes 20.

The skilled person will observe that the dashed arrows inside the nodes 20 in FIGS. 1, 2, 4, and FIG. 5 represent the possible connection derivations resulting from this loopback mechanism LBM.

According to another optional complement, for each data transport frame 26, the processing module 28 of only one respective node 20 is authorized to write data in said frame 26 for sending data to one or more of the other equipment 18, and the processing modules 28 of all other nodes 20 are authorized only to read data from said frame 26. In other words, according to this optional complement, only one respective node 20 has write rights in said frame 26.

Optionally again, the data to be emitted by respective avionics equipment 18 is positioned by the corresponding processing module 28 in a sub-virtual link SVL (Sub-Virtual Link), visible in FIG. 2, potentially several frames 26 at a time. The frames 26 positioned in the sub-virtual links SVL are then positioned by the corresponding processing module 28 in the associated virtual link VL, taking one by one the frames in the sub-virtual links SVL. This mechanism, called a round trip, illustrated by the RT arrows in FIG. 2, allows not delaying the sending of a small frame by a large train of frames 26.

In addition, the processing module 28 is configured to implement a frame collection mechanism 26 contained in the virtual links VL1, VL2, ..., VLn when the frame(s) 26 having the header of a corresponding virtual link VL1, VL2, ..., VLn traverse the node 20 including said processing module 28.

The skilled person will observe more generally that each processing module 28 is configured to perform on-the-fly processing of the frames 26 transiting through the node 20 corresponding to said processing module 28.

When at least one communication node 20 includes the additional pair of communication ports Rx3, Tx3, and preferably when two communication nodes 20, such as the two master nodes 20MA, 20MP, each include the additional pair of communication ports Rx3, Tx3, the avionics ring communication network 15 according to the invention is then able to be interconnected with another communication network, and, for example, with another ring communication network 15 according to the invention, as shown in FIG. 5.

In the example of FIG. 5, a first ring communication network 15A is interconnected with a second ring communication network 15B. In this example, each network 15A, 15B includes both an active master node 20A and a passive master node 20B, each having the additional pair of communication ports Rx3, Tx3. The interconnection between the first and second networks 15A, 15B is then performed by connecting the active master node 20MA of one network 15A, 15B to the passive master node 20MP of the other network 15B, 15A, each time, via their additional pairs of communication ports Rx3, Tx3 and third wired links 22C connecting a transmitter port Tx3 to a receiver port Rx3 each time. The interconnection data flows are declared in the two sequencing modules 25 of the two networks 15A, 15B, so that the incoming data flows in a network 15A, 15B through a transmitter port Tx3 are inserted by copy when the frame 26 having the same identifier circulates on said network 15A, 15B.

In terms of availability and fault tolerance, two ring communication networks 15A, 15B according to the invention connected to each other are equivalent to a star topology switched with four switches, compliant with the ARINC 664 Part 7 standard.

This architecture with two ring communication networks 15A, 15B according to the invention connected to each other is illustrated in two examples of implementation in FIG. 6.

According to a first example, a first installation IT1 then comprises six display screens DP1, DP2, DP3, DP4, DP5, DP6, four electronic computing boards CPU1, CPU2, CPU3, CPU4, and four electronic input-output boards IOM1, IOM2, IOM3, IOM4, each of these screens, electronic computing boards, or even electronic input-output boards forming the avionics equipment 18, and then being associated with a respective communication node 20. In this example, the communication node 20 is moreover integrated into the respective avionics equipment 18 to which it is associated. The first installation IT1 also includes three sensors S1, S2, S3, connected to the electronic input-output boards IOM1, IOM2, IOM3, IOM4.

In the first example of FIG. 6, three display screens DP1, DP2, DP5, two electronic computing boards CPU1, CPU2, and two electronic input-output boards IOM1, IOM2 are then interconnected via the first ring communication network 15A; and the three respective other display screens DP3, DP4, DP6, the two other electronic computing boards CPU3, CPU4, and the two other electronic input-output boards IOM3, IOM4 are then interconnected via the second ring communication network 15B. The interconnection between the first and second communication networks 15A, 15B is then performed via the communication nodes 20 integrated into the four electronic computing boards CPU1, CPU2, CPU3, CPU4, for example, these nodes 20 forming the two master nodes, active 20MA and passive 20MP, respectively.

According to a second implementation example in FIG. 6, a second installation IT2 comprises the same avionics equipment 18 as the first installation IT1 and the first and second communication networks 15A, 15B interconnected as for the first installation IT1.

According to this second example, the second installation IT2 further comprises an additional star communication network 40 with switches 42 and associated wired links 44 allowing interconnecting said avionics equipment 18, i.e., the six display screens DP1, DP2, DP3, DP4, DP5, DP6, four electronic computing boards CPU1, CPU2, CPU3, CPU4, and four electronic input-output boards IOM1, IOM2, IOM3, IOM4, also according to a star topology.

This hybrid architecture according to the second example with the first and second communication networks 15A, 15B according to the invention, on the one hand, and the additional star communication network 40 with switches 42 according to the state of the art on the other hand then allows achieving a high level of architectural dissimilarity to offer even better availability and fault tolerance.

Thus, the avionics ring communication network 15 according to the invention forms a switchless network with a loop topology, having availability equivalent to a state-of-the-art network compliant with the ARINC 664 Part 7 standard while providing the following improvements over this state-of-the-art network:

superior integrity to the state-of-the-art network, due to the monitoring performed by the monitoring module 30, notably with the detection of the failure case corresponding to an abnormal transmission delay of a frame 26;

better performance in terms of jitter, notably due to the absence of a switch, allowing widening the field of use of the communication network 15 according to the invention, by allowing data flows with very low jitter of the order of a microsecond;

inherent determinism allowing significantly simplifying the classification of the communication network 15 according to the invention, and making possible an incremental classification of said network 15;

the possibility of temporally synchronizing the avionics equipment 18 interconnected via said communication network 15 according to the invention, with synchronization of the order of a microsecond.

Moreover, the size, weight, and power consumption, or SWaP, of the avionics communication network 15 according to the invention, as well as its cost, are significantly improved compared to the state-of-the-art network, with the elimination of switches and the reduction of cabling.

The performance of the communication network 15 according to the invention is also improved thanks to deterministic programming of communication flows allowing controlling it and, for the data flows that require it, achieving a jitter of the order of a microsecond.

The determinism and incremental classification of the communication network 15 according to the invention are obtained thanks to the deterministic programming of communication flows, by generating data transport frames 26 at regular temporal intervals, for example in the form of virtual links, serving as vectors, or "vehicles," for transporting this data.

Moreover, unlike some state-of-the-art communication networks implementing an arbitration protocol, the avionics communication network 15 according to the invention does not require an arbitration protocol, since only one of the communication nodes is authorized to generate transport frames at a given time and there is then no risk of collision between frames.

It is thus conceived that the avionics communication network 15 according to the invention is improved compared to the state-of-the-art network.

1. An avionics ring communication network, intended to be onboard a civil aircraft and comprising at least three communication nodes connected in a ring shape,
each communication node including at least one pair of communication ports and being directly connected between a respective previous node and a respective following node via two respective distinct ports, the communication ports of two successive nodes of the ring being connected via a wired data link,
at least one communication node including a sequencing module configured to generate data transport frames, each frame circulating in a loop successively from node to node,
each communication node being intended to be connected to respective avionics equipment and including a processing module configured to receive data intended for said avionics equipment from other avionics equipment, via the generated frames, and/or to send data from said avionics equipment to at least one other avionics equipment,
at a given time, only one of the communication nodes being configured to generate the data transport frames, the sequencing module being activated for only one of the communication nodes at a time.

2. The network according to claim 1, wherein each communication node includes the sequencing module and the processing module.

3. The network according to claim 1, wherein at least one communication node includes a monitoring module configured to compare an inter-frame period to a predefined range of values, a frame anomaly being detected if the inter-frame period does not belong to said range, the inter-frame period being the difference between two temporal instances of reception of successive frames by the node including the monitoring module.

4. The network according to claim 3, wherein each communication node includes the monitoring module and the processing module.

5. The network according to claim 4, wherein the monitoring module is activated for all communication nodes.

6. The network according to claim 3, wherein each communication node includes the sequencing module and the processing module, and wherein each communication node includes the sequencing module, the monitoring module, and the processing module.

7. The network according to claim 6, wherein the monitoring module is activated for all communication nodes.

8. The network according to claim 1, wherein among the communication nodes, two communication nodes, called master nodes, each include the sequencing module and the monitoring module, the sequencing module then being activated for one master node, called the active master node, and the monitoring module being activated for the other master node, called the passive master node.

9. The network according to claim 8, wherein the communication nodes, called slave nodes, other than the master nodes include only the processing module among the sequencing, monitoring, and processing modules.

10. The network according to claim 1, wherein each communication node includes a first pair of communication ports and a second pair of communication ports, redundant to the first pair; the communication ports of the first pairs being successively connected via first wired data links, and the communication ports of the second pairs being successively connected via second wired data links, redundant to the first links.

11. The network according to claim 10, wherein the first and second wired links are arranged in parallel to each other between two successive nodes of the ring; and the processing modules of said nodes are configured to circulate data in a first direction on the first link, and in a respective second direction, opposite to the first direction, on the second link.

12. The network according to claim 10, wherein each pair of ports includes a receiver port and a transmitter port; and
if both ports of the first pair are functional, the processing module is configured to acquire a frame received on the receiver port of the first pair, to process said frame, then to send the processed frame via the transmitter port of the first pair; and the processing module is configured to transfer without processing, to the transmitter port of the second pair, each frame received on the receiver port of the second pair;
if the receiver port of the first pair is non-functional, the processing module is configured to acquire a frame received on the receiver port of the second pair, to process said frame, then to send the processed frame via the transmitter port of the first pair; and
if the transmitter port of the first pair is non-functional, the processing module is configured to acquire a frame received on the receiver port of the first pair, to process said frame, then to send the processed frame via the transmitter port of the second pair.

13. The network according to claim 1, wherein at least one communication node includes an additional pair of communication ports configured to be connected to another communication network.

14. The network according to claim 1, wherein the sequencing module is configured to generate the data transport frames in the form of virtual links according to the ARINC 664 Part 7 standard, and to associate a respective inter-frame space to each virtual link, the inter-frame space being a minimum duration between temporal instances of the start of two successive frames of the corresponding virtual link.

15. The network according to claim 1, wherein for each data transport frame, the processing module of only one respective node is authorized to write data in said frame for sending data to one or more of the other equipment, and the processing modules of all other nodes are authorized only to read data from said frame.

16. A civil aircraft comprising an avionics ring communication network according to claim 1 and avionics equipment interconnected via said network.
